(19) United States
(12) Patent Application Publication
(10) Pub. No.: US 2003/0060172 A1
(43) Pub. Date: Mar. 27, 2003

(54) Radio frequency module

(76) Inventors: Akira Kuriyama, Kokubunji (JP); Tomonori Tanoue, Machida (JP); Kenji Sekine, Hinode (JP); Masami Ohnishi, Hachioji (JP); Osamu Kagaya, Tokyo (JP); Atsushi Isobe, Kodaira (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/252,512

(22) Filed: Sep. 24, 2002

(30) Foreign Application Priority Data
Sep. 26, 2001 (JP) 2001-292788

(51) Int. Cl. H04B 1/38; H04B 1/16

(52) U.S. Cl. 455/90; 455/334

(57) ABSTRACT

A radio frequency module includes a first circuit board and a second circuit board. A first circuit element group is placed in a cavity formed on the upper surface of the first circuit board, and a second circuit element group is placed on the upper surface of the second circuit board. The first and second circuit boards are provided with terminal electrodes by which electrical connection is established. The radio frequency module is formed by vertically connecting the two circuit boards together. Heat emitted by the first circuit element group is transferred to a heat radiation section, which is formed on the lower surface of the first circuit board, via through-holes connecting the bottom of the cavity with the heat radiation section.

### BACKGROUND OF THE INVENTION

The present invention relates to a radio frequency module which is employed for a radio frequency mobile communication terminal, and in particular, to miniaturization of the radio frequency module and the improvement of its heat release capability.

As the composition of a conventional radio frequency module, an example has been disclosed in JP-A-9-283700. The composition of the radio frequency module of the document will be explained employing reference numerals which are used in FIG. 1 of the document, in which reference numeral “2” denotes a multilayer circuit board which is mainly composed of glass, “5” denotes a semiconductor device, and “6” denotes a passive element such as a capacitor and resistor. The semiconductor device 5 is fixed to an open cavity 11, which is formed on the upper surface of the multilayer circuit board 2, using resin-based or solder-based connecting paste 12, and is sealed with resin 13. Reference numeral “14” denotes a case. The case 14 is attached so as to cover the upper surface of the multilayer circuit board 2 after the semiconductor devices 5 and the passive elements 6 are installed or mounted on the upper surface of the multilayer circuit board 2, and is sealed with sealing resin and so forth. The bottom of the open cavity 11 is connected with a grounding metal layer 9, which is formed on the backside surface of the multilayer circuit board 2, by a thermal via-hole 8 so that heat emitted by the semiconductor device 5 is transferred to the grounding metal layer 9 via the thermal via-hole 8, by which the heat release capability of the radio frequency module is improved.

Another example of the composition of a conventional radio frequency module has been disclosed in JP-A-2000-12770. The composition of the radio frequency module of the document will be explained employing reference numerals of FIG. 1 of the document, in which reference numeral “15” denotes a first semiconductor device, “23a” and “23b” denote second semiconductor devices, “400” denotes a first wiring board, “21” denotes a second wiring board, “26” denotes sealing resin, “12” denotes a cavity formed on the upper surface of a first dielectric circuit board 11, “14” denotes an external connection terminal, “13” denotes an upper surface connection terminal formed on part of the upper surface of the first wiring board 11 other than the cavity 12, “22” denotes an lower surface connection terminal formed on the backside surface of the second wiring board 21 so as to correspond to the upper surface connection terminal 13, and “31” denotes an anisotropic conductive adhesive agent.

The first semiconductor device 15 is bonded to the cavity 12 of the first wiring board 11 using an insulating adhesive agent 16 and is electrically connected to a conductor pattern on the first wiring board 11 by bonding wires 17, thereby a first structure 10 is formed. The second semiconductor devices 23a and 23b are bonded to the second wiring board 21 using the insulating adhesive agent 16 and are electrically connected to a conductor pattern on the second wiring board 21 by bonding wires 17, and the upper surface of the second wiring board 21 is sealed with sealing resin, thereby a second structure 20 is formed.

The first structure 10 and the second structure 20 are vertically connected together, and the upper surface connection terminals 13 are connected with the lower surface connection terminals 22 by use of the anisotropic conductive adhesive agent 31, thereby the first structure 10 and the second structure 20 are electrically connected together.

Still another example of the composition of a conventional radio frequency module has been disclosed in JP-A-2000-174204. The composition of the radio frequency module of the document will be explained employing reference numerals of FIG. 7 of the document, in which reference numeral “19” denotes a first semiconductor device, “29” denotes a second semiconductor device, “11” denotes a metal base, “1” denotes a first dielectric circuit board formed on the upper surface of the metal base 11, “2” denotes a second dielectric circuit board, “12” denotes a metal cover, “4” denotes a cavity formed on the upper surface of the first dielectric circuit board 1. The metal base 11 is exposed from the bottom of the cavity 4. Reference numeral “120” denotes a radio frequency circuit device such as a chip capacitor, which does not require hermetic sealing.

The first semiconductor device 19 is mounted on the metal base 11 which is exposed from the bottom of the cavity 4 formed on the first dielectric circuit board 1, and is electrically connected to first DC lines 17 formed on the first dielectric circuit board 1 by use of bonding wires 10. The second dielectric circuit board 2 is stacked on the upper surface of the first dielectric circuit board 1. The second semiconductor device 29 is mounted on the upper surface of the second dielectric circuit board 2, and is electrically connected to second DC lines 27 formed on the second dielectric circuit board 2 by use of bonding wires 20. The first DC lines 17 are electrically connected with the second DC lines 27 by via-holes 8.

The upper surface of the second dielectric circuit board 2 is hermetically sealed by the metal cover 12. The radio frequency circuit device 120 such as a chip capacitor, which does not require hermetic sealing, is mounted on part of the first dielectric circuit board 1 which is not hermetically sealed by the metal cover 12.

Still another example of the composition of a conventional radio frequency module has been disclosed in JP-A-2000-31331. The composition of the radio frequency module of the document will be explained employing reference numerals of FIGS. 3 and 5 of the document, in which reference numeral “21” denotes a first transistor which is an active element, “22” denotes a second transistor which is an active element, “60” denotes a cap, “13” denotes a ground terminal formed on the lower surface of the cap 60, “61” denotes a thermal via-hole, “4” and “5” denote passive elements, “25” denotes a cover, “17” and “18” denote pads for connecting bump terminals and so forth mechanically and electrically, and “19” and “20” denote internal via-holes for providing the pads 17 and 18 with electrical connection.

Between the ground terminal 13 and the pads 17 and 18 to which the first transistor 21 and the second transistor 22 are connected via bumps, the thermal via-holes 61 are formed in order to provide thermal and electrical connection. The cap 60 is bonded so as to totally cover the cavities 11 and 12. The passive elements 4 and 5 which are covered with the cover 25 are electrically connected to the first transistor 21 and the second transistor 22 via the internal via-holes 19 and 20 and the pads 17 and 18.

However, the conventional radio frequency modules which have been explained above involve the following problems or drawbacks.

In the example of JP-A-9-283700, the semiconductor device and the passive element are installed or mounted only on the upper surface of the multilayer circuit board, therefore, the circuit board is necessitated to have a large area, taking extra area necessary for mounting circuit elements into consideration.

The above problem can be resolved and the area of the radio frequency module can be reduced by employing the composition of JP-A-2000-12770 for a radio frequency module, since a plurality of semiconductor devices can be placed in a three-dimensional arrangement. However, the composition has no structure for leading and dissipating heat emitted by the semiconductor devices to outside of the radio frequency module. Further, the semiconductor devices are bonded to the dielectric circuit boards by use of the insulating adhesive agent which has lower thermal conductivity in comparison with conductive adhesive agents such as a solder-based connecting paste, therefore, the heat release capability of the radio frequency module is necessitated to be lower than that of the composition of JP-A-9-283700, thereby the performance of the radio frequency module might be deteriorated.

In the example of JP-A-2000-174204, the semiconductor device is directly mounted on the metal base, thereby the heat emitted by the semiconductor device can be dissipated efficiently and the heat radiation problem can be resolved. Further, the composition enables three-dimensional arrangement of a plurality of semiconductor devices, therefore, the reduction of circuit board area is possible when only the semiconductor devices are taken into consideration. However, the radio frequency circuit device such as a chip capacitor has to be mounted on the first dielectric circuit board on which the semiconductor device is mounted, similarly to the example of JP-A-9-283700, and thus the reduction of circuit board area becomes difficult in a radio frequency module which includes a semiconductor device and a radio frequency circuit device such as a chip capacitor. Further, in such composition in which the semiconductor device is directly mounted on the metal base, the metal base is required to be thick to have high strength, and the thickness of the metal base used to cause weight gain of the radio frequency module. In addition, such composition, in which the dielectric circuit board is formed on the upper surface of the metal base, requires a more complicated manufacturing process in comparison with a case where a metal layer is simultaneously formed on the lower surface of the dielectric circuit board.

The example of JP-A-2000-31331 is a little advantageous from the viewpoint of heat release capability since the first and second transistors as active elements are connected to the ground terminal via the thermal via-holes. However, the active elements emitting heat are mounted by means of face-down connection via bumps, therefore, the heat release capability of the module tends to be insufficient in comparison with cases where face-up connection is employed.

### SUMMARY OF THE INVENTION

It is therefore an object of the present invention to provide a radio frequency module which has improved heat release capability, which can be formed in a smaller size, and which can be manufactured by a simple manufacturing process.

In accordance with an aspect of the present invention, there is provided a radio frequency module comprising a first circuit block and a second circuit block. The first circuit block includes a first circuit board, a first circuit element placed on the first circuit board, a heat radiation section formed on a surface of the first circuit board opposite to a surface on which the first circuit element is placed, a first through-hole penetrating the first circuit board between the surface on which the first circuit element is placed and the heat radiation section, for transferring heat emitted by the first circuit element to the heat radiation section, and a first connection point formed on a surface of the first circuit board opposite to the surface on which the heat radiation section is formed. The second circuit block includes a second circuit board, a second circuit element placed on the second circuit board, and a second connection point formed on a surface of the second circuit board opposite to a surface on which the second circuit element is placed. The first circuit block and the second circuit block are formed so as to be connectable with each other, and a sealed cavity containing the first circuit element is completed and the first connection point makes contact with the second connection point so as to electrically connect the first circuit element with the second circuit element when the first circuit block and the second circuit block are connected together.

In a radio frequency module in accordance with the present invention, a cavity formed on the first circuit board is hermetically sealed with the second circuit board when the first circuit block and the second circuit block are connected together and thereby the aforementioned sealed cavity is completed. A first circuit element group is placed inside the sealed cavity and a second circuit element group is placed on the upper surface of the second circuit board, thereby the reduction of circuit board area is made possible.

Further, heat emitted by the first circuit element group is transferred from the bottom of the sealed cavity, in which the first circuit element group is placed, to the heat radiation section via the first through-holes, thereby the heat release capability of the radio frequency module is improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross-sectional view of a radio frequency module in accordance with a first embodiment of the present invention;

FIG. 2 is a perspective view of the radio frequency module in accordance with the first embodiment;

FIG. 3 is a circuit diagram of the radio frequency module in accordance with the first embodiment;

FIG. 4 is a flow chart briefly explaining a method for using the radio frequency module of the first embodiment;

FIG. 5 is a cross-sectional view of a radio frequency module in accordance with a second embodiment of the present invention;

FIG. 6 is a circuit diagram of the radio frequency module in accordance with the second embodiment;

FIG. 7 is a cross-sectional view of a radio frequency module in accordance with a third embodiment of the present invention;

FIG. 8 is a cross-sectional view of a radio frequency module in accordance with a fourth embodiment of the present invention;

FIG. 9 is a circuit diagram of the radio frequency module in accordance with the fourth embodiment;

FIG. 10 is a cross-sectional view of a radio frequency module in accordance with a fifth embodiment of the present invention;

FIG. 11 is a circuit diagram of the radio frequency module in accordance with the fifth embodiment;

FIG. 12 is a cross-sectional view of a radio frequency module in accordance with a sixth embodiment of the present invention;

FIG. 13 is a flow chart briefly showing a method for manufacturing the radio frequency module of the first embodiment;

FIG. 14 is a flow chart briefly showing another method for manufacturing the radio frequency module of the first embodiment; and

FIG. 15 is a circuit diagram showing a radio frequency mobile communication terminal as a radio frequency module in accordance with a seventh embodiment of the present invention.

### DESCRIPTION OF THE EMBODIMENTS

Referring now to the drawings, a description will be given in detail of embodiments in accordance with the present invention. In the following, the composition of several radio frequency power amplifier modules will be explained in detail as examples of the radio frequency modules in accordance with the present invention.

(First Embodiment)

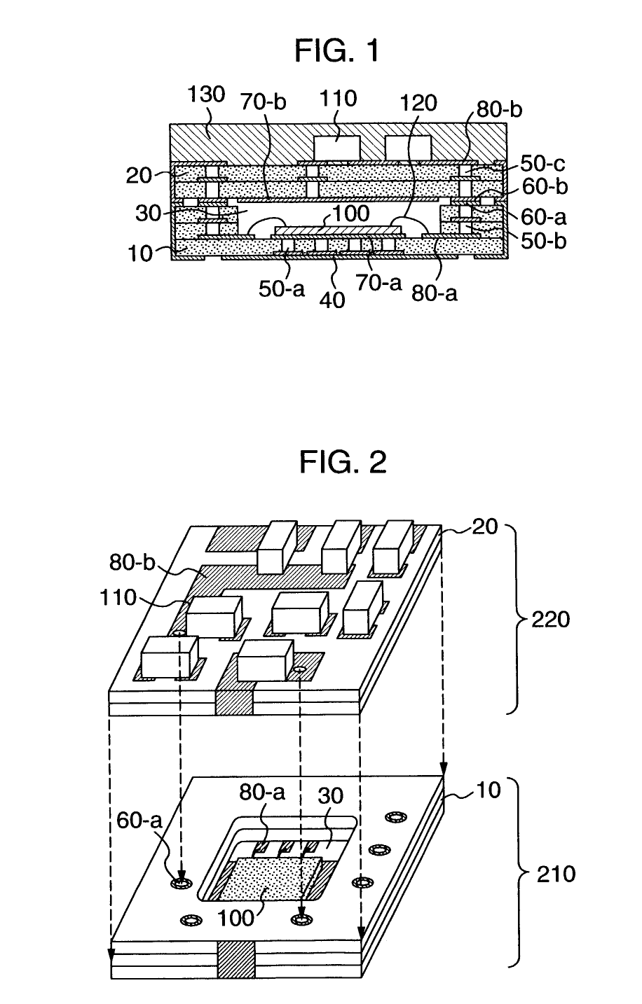

FIGS. 1, 2 and 3 are a cross-sectional view, a perspective view and a circuit diagram of a radio frequency power amplifier module, respectively, in accordance with a first embodiment of the present invention. In FIGS. 1 and 2, reference numeral “10” denotes a first circuit board, “30” denotes a cavity formed on the upper surface of the first circuit board 10, “40” denotes a heat radiation section formed on the lower surface of the first circuit board 10, “70-a” denotes a first grounding metal layer formed on the bottom of the cavity 30, “50-a” denotes a first through-hole for connecting the first grounding metal layer 70-a with the heat radiation section 40, “60-a” denotes a first connection point formed on part of the upper surface of the first circuit board 10 other than the cavity 30, “80-a” denotes a first transmission line provided to the first circuit board 10, “50-b” denotes a second through-hole for connecting the first transmission line 80-a with the first connection point 60a, “100” denotes a semiconductor device, “120” denotes a bonding wire, and “210” denotes a first circuit block.

Reference numeral “20” denotes a second circuit board, “60-b” denotes a second connection point formed on the lower surface of the second circuit board 20 so as to be overlaid on the first connection point 60-a on the upper surface of the first circuit board 10 when the two circuit boards 10 and 20 are stacked up and connected together, “80-b” denotes a second transmission line provided to the second circuit board 20, “50-c” denotes a third through-hole for connecting the second transmission line 80-b with the second connection point 60-b, “70-b” denotes a second grounding metal layer formed on the lower surface of the second circuit board 20, “110” denotes a passive element such as a capacitor, inductor and resistor, which is mounted on the upper surface of the second circuit board 20, “130” denotes sealing resin, and “220” denotes a second circuit block.

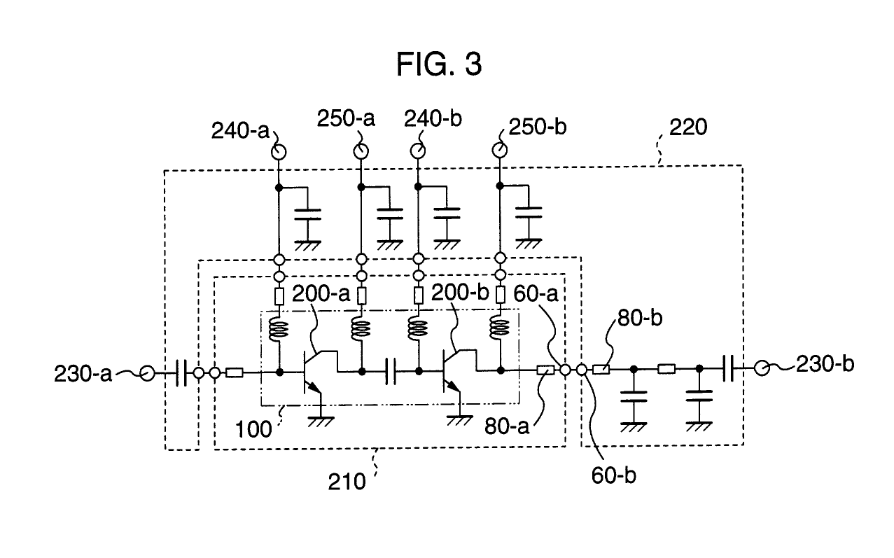

Referring to the circuit diagram of FIG. 3, reference numeral “210” denotes the first circuit block, “220” denotes the second circuit block, “200-a” denotes a first transistor of the first circuit block 210, “200-b” denotes a second transistor of the first circuit block 210, “230-a” denotes an input power terminal, “230-b” denotes an output power terminal, “240-a” denotes a control voltage terminal of the first transistor 200-a, “240-b” denotes a control voltage terminal of the second transistor 200-b, “250-a” denotes a supply voltage terminal of the first transistor 200-a, and “250-b” denotes a supply voltage terminal of the second transistor 200-b.

The semiconductor device 100 is fixed to the first grounding metal layer 70-a on the bottom of the cavity 30 by means of face-up mounting using a conductive connecting paste such as solder paste or silver paste. The emitters of the first transistor 200-a and the second transistor 200-b are connected to the first grounding metal layer 70-a through the backside surface of the semiconductor device 100. Electrode terminals of the semiconductor device 100 other than those for the emitters are formed on the upper surface of the semiconductor device 100 (not shown). The output terminal of the second transistor 200-b of the semiconductor device 100 is connected to the first transmission line 80-a by the bonding wire 120. The other electrode terminals formed on the upper surface of the semiconductor device 100 are connected to the transmission lines of the first circuit board 10 by use of bonding wires 120, thereby the first circuit block 210 is completed.

Heat emitted by the semiconductor device 100 is transferred from the first grounding metal layer 70-a to the heat radiation section 40 via the first through-holes 50-a. The first through-hole 50-a is a cylindrical through-hole whose diameter is 0.1 mm or more. Inside the first through-hole 50-a can be hollow; however, the heat release capability can be increased by filling the hole with material having high thermal conductivity. A plurality of first through-holes 50-a are provided to the first circuit board 10. For example, when the diameter of the first through-hole 50-a is 0.1 mm, it is desirable that the first through-holes 50-a be arranged in a hound's tooth check with a center distance of 0.3 mm or less.

It is desirable that the first circuit board 10 be formed of alumina ceramics having high thermal conductivity; however, glass ceramics or resin can also be employed. Preferably, the heat radiation section 40 is formed of metal material having higher thermal conductivity than the first circuit board 10.

The passive elements 110 are mounted on the upper surface of the second circuit board 20 by use of a conductive connecting paste such as solder, and the upper surface of the second circuit board 20 is hermetically sealed with the sealing resin 130 (not shown in FIG. 2), thereby the second circuit block 220 is completed. While the sealing resin 130 is used in the example for the hermetic sealing of the upper surface of the second circuit board 20, a resin case or a metal case can also be used instead of the sealing resin 130.

The first circuit block 210 and the second circuit block 220 are vertically connected together, and the first connection points 60-a are connected with the second connection points 60-b by use of solder bumps or a conductive connecting agent such as a silver paste, or an anisotropic conductive sheet, thereby the radio frequency power amplifier module of the first embodiment is completed.

The first circuit board 10 and the second circuit board 20 are not necessarily required to be made of the same material; however, the use of the same material is preferable for the prevention of separation of the second connection points 60-b from the first connection points 60-a due to external factors after the connection such as thermal expansion/shrinkage. Further, it is obvious that the accuracy of positions of the first connection points 60-a and the second connection points 60-b formed on the first circuit board 10 and the second circuit board 20, respectively, can be improved easily by employing the same material for the two circuit boards.

The cavity 30 formed on the upper surface of the first circuit board 10 is sealed up with the second grounding metal layer 70-b which is formed on the lower surface of the second circuit board 20, thereby a sealed cavity is completed. Therefore, the semiconductor device 100 placed in the cavity 30 is hermetically sealed with the second grounding metal layer 70-b of the second circuit block 220 automatically.

Incidentally, while the first circuit block 210 is assumed to be a two-stage amplifier circuit for the sake of convenience in the above explanation of the first embodiment, the number of the amplifier circuit stages can of course be one or three or more.

As described above, in the radio frequency power amplifier module of the first embodiment, the semiconductor device 100 and the passive element 110 are not placed on the same plane or circuit board but are placed on two vertically separable circuit boards, and the circuit boards are stacked up and connected together, thereby three-dimensional arrangement of the semiconductor device 100 and the passive element 110 becomes possible. In radio frequency power amplifier modules of the size of 6 mm×6 mm which are generally mass-produced today, an area of as large as approximately 20 mm² is occupied by circuit parts other than the semiconductor device. Therefore, by placing the semiconductor device and the passive element on different circuit boards, the area of the module can be decreased to 4.5 mm×4.5 mm or less.

Further, in the first embodiment, heat emitted by the semiconductor device 100 is transferred from the first grounding metal layer 70-a, on which the semiconductor device 100 is mounted, to the heat radiation section 40, which is formed of a metal material having high thermal conductivity, via the first through-holes 50-a, thereby the heat release capability of the module is increased.

Furthermore, in the first embodiment, for the vertical connection between the first circuit block 210 and the second circuit block 220, the first connection points 60-a are electrically connected with the second connection points 60-b by use of solder bumps, a conductive connecting agent such as a silver paste, or an anisotropic conductive sheet. By such a method, the registration of the first connection points 60-a with the second connection points 60-b can be conducted easily and correctly, thereby miniaturization of the connection points and miniaturization of the module are made possible, and a manufacturing method for the radio frequency module of the present invention which will be explained below can be made simpler and easier.

In the following, an example of a method for manufacturing a radio frequency module of the present invention will be explained in detail.

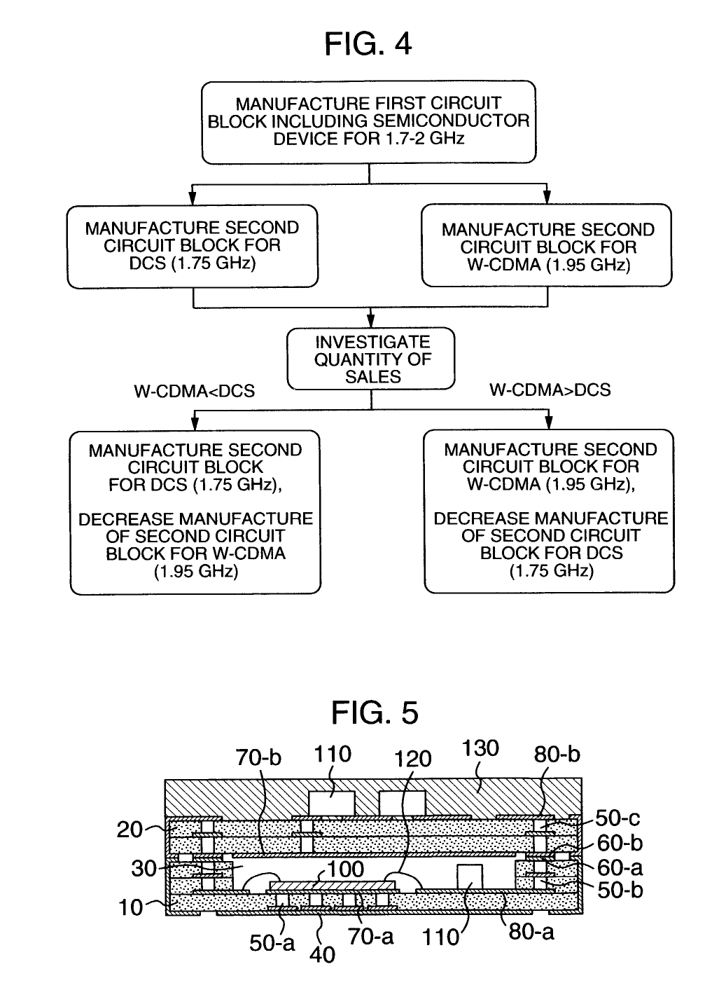

FIG. 4 is a flow chart for briefly explaining a method for using the radio frequency power amplifier module of the first embodiment as an example of a method for using a radio frequency module in accordance with the present invention. In FIG. 4, DCS (transmission frequency: 1.75 GHz) and W-CDMA (transmission frequency: 1.95 GHz) are taken as examples of communication methods which can be employed by the radio frequency power amplifier module, for the sake of convenience.

In the example shown in FIG. 4, three types of circuit blocks: a first circuit block including a semiconductor device for 1.7-2.0 GHz; a second circuit block including a matching circuit for giving the best characteristics to the power amplifier module at the transmission frequency of DCS and in the modulation method of DCS; and another second circuit block including a matching circuit for giving the best characteristics to the power amplifier module at the transmission frequency of W-CDMA and in the modulation method of W-CDMA are manufactured, respectively. The quantity of sales and/or stork of the radio frequency power amplifier modules is investigated with regard to both DCS and W-CDMA, and based on the investigation, the number of the second circuit blocks for each communication method (DCS and W-CDMA) to be manufactured is controlled and adjusted properly.

The second circuit block for DCS and the second circuit block for W-CDMA are different from each other from the viewpoints of circuit constants such as a capacitor and transmission lines, and the lengths of transmission lines. However, they can be illustrated by the same circuit diagram as the second circuit block 220 shown in FIG. 3. In other words, the two second circuit blocks for DCS and W-CDMA have the same circuit pattern. Therefore, the second circuit blocks for each communication method (DCS and W-CDMA) can be designed and manufactured so as to be connectable to the common first circuit block 210 having fixed connection points.

In the above manufacturing method for the radio frequency module in accordance with the present invention, the connection of the first circuit block 210 with the second circuit block 220 can be made after manufacturing the first circuit blocks 210 and the second circuit blocks 220, respectively. Therefore, the numbers of the first circuit blocks 210 and the second circuit blocks 220 to be manufactured can be controlled and adjusted independently, thereby manufacturing costs can be reduced. Each circuit block can be manufactured depending on required functions and such circuit blocks can be connected together into a radio frequency module, therefore, radio frequency modules for various applications can be manufactured and provided in a short period. Incidentally, it is also possible to connect the second circuit board 20 onto the first circuit board 10 before the completion of the second circuit block 220 and thereafter mount the passive element 110 on the upper surface of the second circuit board 20. In this case, trimming of the semiconductor device 100 and the passive element 110 becomes easier.

According to this manufacturing method, the first circuit block 210 can be shared by a plurality of power amplifier modules for various communication methods, thereby the time and costs for developing and manufacturing the radio frequency power amplifier modules supporting various communication methods can be reduced considerably. The number of second circuit blocks to be manufactured can be adjusted properly depending on market trends and the number can also be distributed to other or new communication methods easily, therefore, inventory adjustment and shipping number control can be made easier.

Incidentally, while the first circuit block is shared and the second circuit block is diversified in the above example, the radio frequency power amplifier module of the first embodiment can also be designed to share the second circuit block and diversify the first circuit block. It is also possible to manufacture and provide power amplifier modules of various grades and prices easily, by making a selection of the passive element of the second circuit block from a plurality of passive elements of various prices depending on the price of the power amplifier module to be manufactured.

(Second Embodiment)

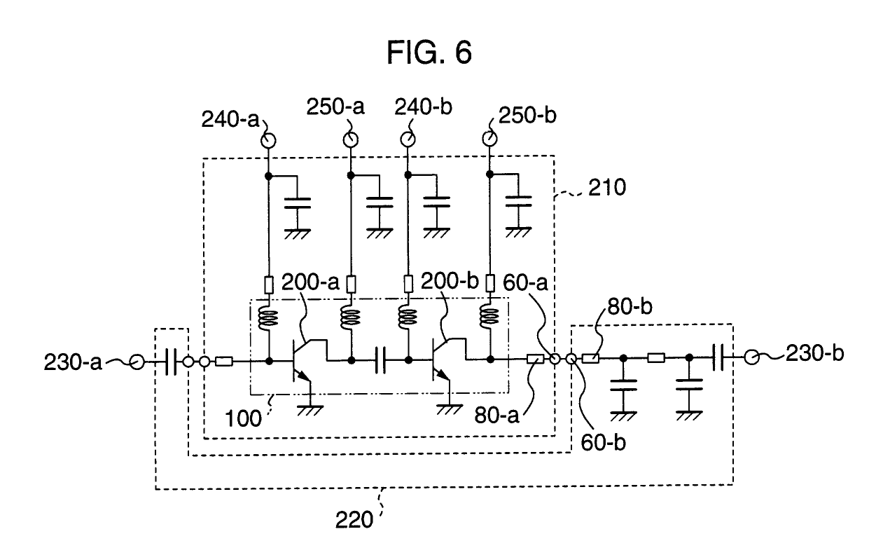

FIGS. 5 and 6 are a cross-sectional view and a circuit diagram of a radio frequency power amplifier module, respectively, in accordance with a second embodiment of the present invention. In the second embodiment, the semiconductor device 100 and a direct current circuit system are placed in the first circuit block 210, and a radio frequency circuit system is placed in the second circuit block 220. In addition to the semiconductor device 100 another passive element 110 is placed in the cavity 30 on the upper surface of the first circuit board 10. The other composition is basically the same as that of the first embodiment.

In the radio frequency power amplifier module of the second embodiment, the direct current circuit system which can generally be shared by various communication methods and frequencies is put together in the first circuit block. On the other hand, only the radio frequency circuit system has to be fabricated on the second circuit block. Therefore, the division of circuits of the radio frequency power amplifier module into the two circuit blocks can be made easily and clearly. The using method for the radio frequency power amplifier module of the second embodiment is basically the same as that of the first embodiment, and thus repeated description thereof is omitted for brevity.

(Third Embodiment)

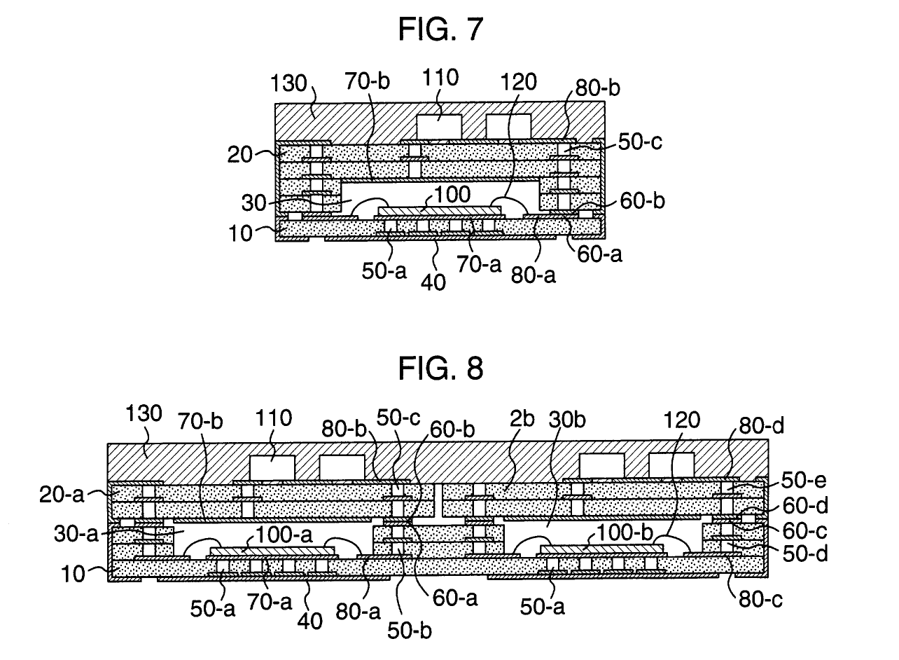

FIG. 7 is a cross-sectional view of a radio frequency power amplifier module in accordance with a third embodiment of the present invention. In the third embodiment, the cavity 30 is formed on the lower surface of the second circuit board 20 and the semiconductor device 100 mounted on the upper surface of the first circuit board 10 is sealed with the cavity 30 when the first circuit board 10 and the second circuit board 20 are stacked up and connected together. The other composition is basically the same as that of the first embodiment.

In the third embodiment, basically the same effects as those of the first embodiment can be obtained. The using method for the radio frequency power amplifier module of the third embodiment is basically the same as that of the first embodiment.

(Fourth Embodiment)

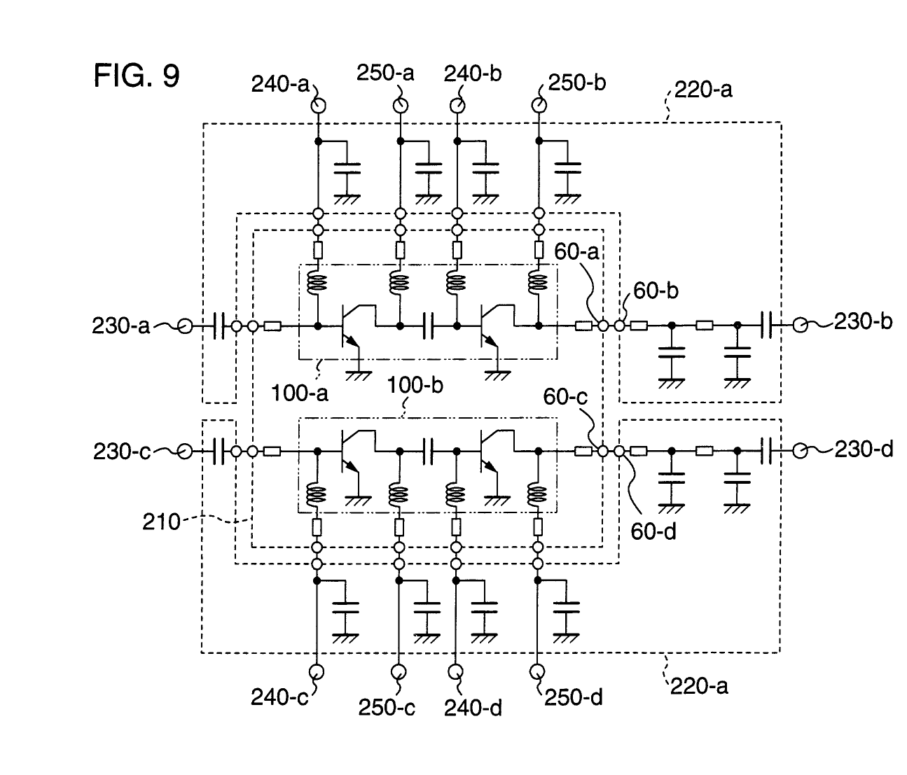

FIGS. 8 and 9 are a cross-sectional view and a circuit diagram of a radio frequency power amplifier module, respectively, in accordance with a fourth embodiment of the present invention. In the fourth embodiment, a first circuit block 210 is fabricated by forming at least two cavities 30-a and 30-b on the upper surface of the first circuit board 10 and placing semiconductor devices 100-a and 100-b in the cavities 30-a and 30-b, respectively. The passive elements 110 are mounted on the upper surfaces of at least two second circuit boards 20-a and 20-b and are sealed with a sealing resin 130, thereby at least second and third circuit blocks are formed. The second and third circuit blocks are horizontally arranged on the upper surface of the first circuit block 210. The other composition is basically the same as that of the first embodiment.

According to the fourth embodiment, a radio frequency module having a plurality of functions can be manufactured easily and provided in a small size.

The radio frequency module of the fourth embodiment can be applied as below. For example, it is possible to combine a transmission power amplifier and a reception power amplifier into an integral-type radio frequency module while combining a transmission power amplifier and a filter into another integral-type radio frequency module. While a transmission power amplifier, a reception power amplifier and a filter are taken as examples here, components having other functions can also be employed and combined, thereby radio frequency modules of various combinations can be manufactured easily.

(Fifth Embodiment)

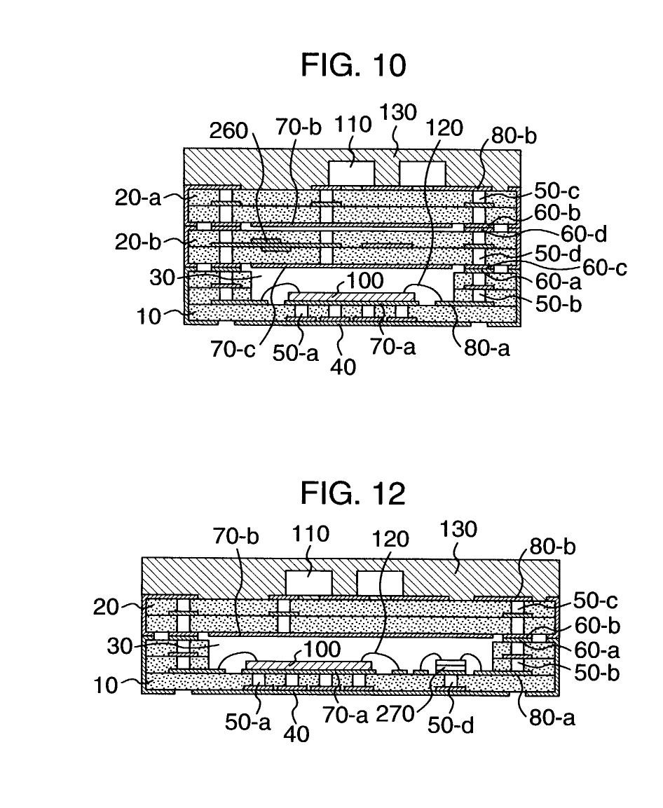

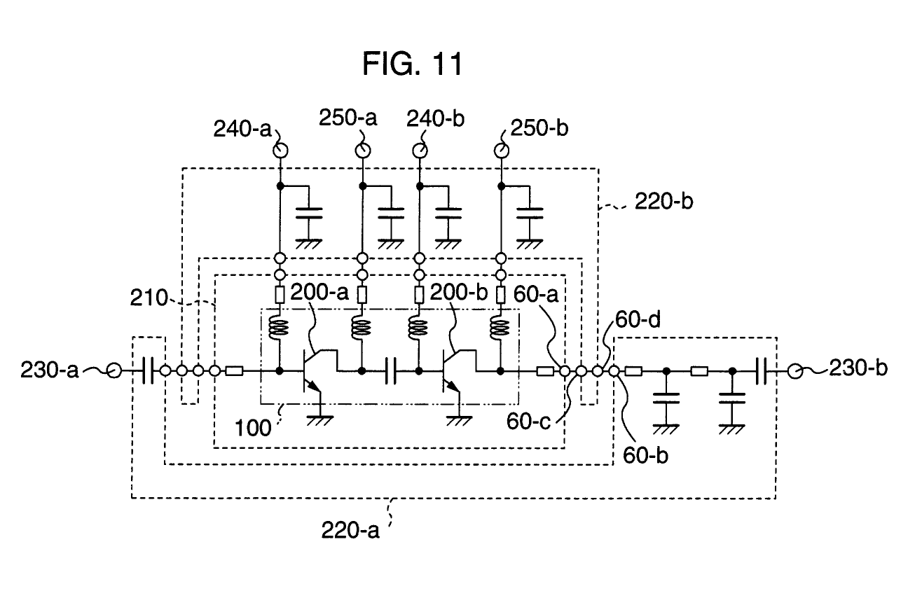

FIGS. 10 and 11 are a cross-sectional view and a circuit diagram of a radio frequency power amplifier module, respectively, in accordance with a fifth embodiment of the present invention. The radio frequency power amplifier module of the fifth embodiment includes: a first circuit block 210 including a semiconductor device 100; a second circuit block 220-a including a radio frequency circuit system; and a third circuit block 220-b including a direct current circuit system. It is different from the first embodiment in that from the bottom, the first circuit block 210, the third circuit block 220-b and the second circuit block 220-a are stacked up and connected together. A passive element 260 included in the third circuit block 220-b is embedded in a third circuit board 20-b of the third circuit block 220-b.

According to the fifth embodiment, circuits of the radio frequency module can be divided more minutely than the second embodiment into a semiconductor device, a direct current circuit system and a radio frequency circuit system, thereby designing of each circuit block can be carried out more easily. Further, by the placement of the direct current circuit system and the radio frequency circuit system on separate circuit boards, the area of the module can be reduced further in comparison with the first embodiment. The radio frequency power amplifier module of the fifth embodiment can be used basically in the same way as the first embodiment.

(Embodiment 6)

FIG. 12 is a cross-sectional view of a radio frequency power amplifier module in accordance with a sixth embodiment of the present invention. In the sixth embodiment, a SAW (Surface Acoustic Wave) element 270 is placed in the cavity 30 of the first circuit board 10 along with the semiconductor device 100. The first circuit board 10 is further provided with a fourth through-hole 50-d which connects the bottom of the cavity 30, on which the SAW element 270 is mounted, with the heat radiation section 40 on the lower surface of the first circuit board 10. The SAW element 270 is hermetically sealed with the second circuit board 20 on which the second circuit block 220 is mounted. The other composition is basically the same as that of the first embodiment.

In the SAW element which is used for a radio frequency part, rotated Y-cut lithium tantalate is used for its a piezoelectric substrate. As the temperature rises, loss of the SAW propagating on the piezoelectric substrate increases by approximately 0.02 dB/°C. Therefore, in order to keep the increase of loss within 0.1 dB, the temperature rise has to be 5° C. or less. Further, since the SAW element has a temperature coefficient of 40 ppm/°C., its frequency characteristics shift to lower frequencies if the temperature of the SAW element rises. Therefore, in order to keep the frequency shift of a branching filter for W-CDMA within 0.2 MHz, the temperature rise has to be kept within 3° C., for example.

According to the sixth embodiment, heat emitted by the SAW element 270 is transferred to the heat radiation section 40 on the lower surface of the first circuit board 10 via the fourth through-hole 50-d, therefore, the SAW element can be integrated with the power amplifier without impairing heat radiation for the SAW element.

In the following, an embodiment of the manufacturing methods for the radio frequency modules in accordance with the present invention will be described more in detail referring to figures.

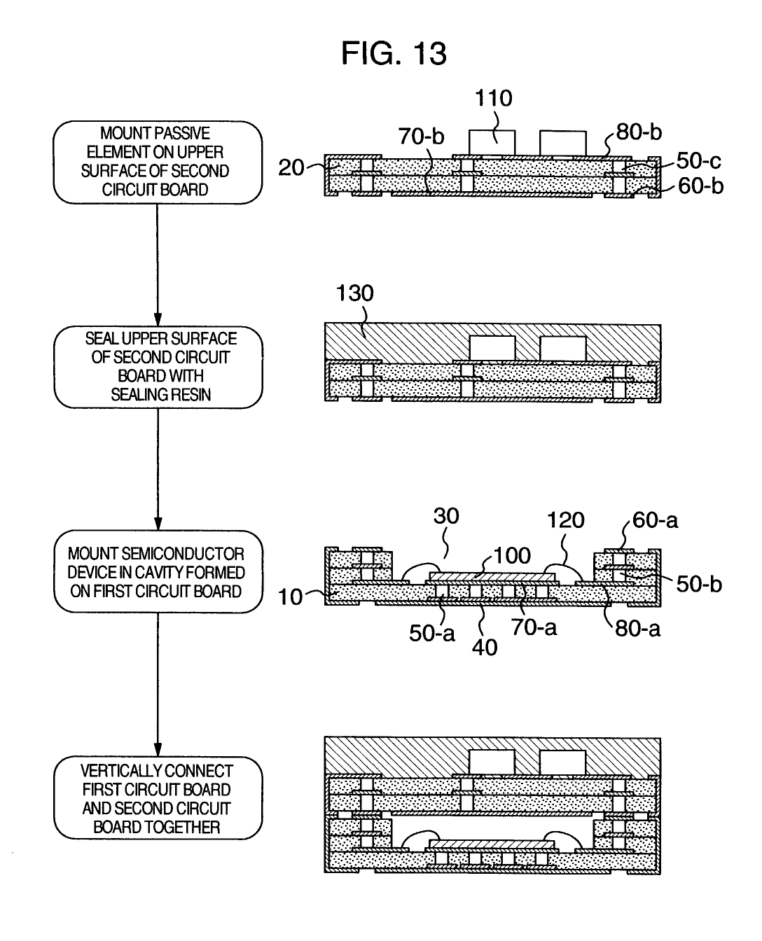

FIG. 13 is a flow chart briefly showing a method for manufacturing the radio frequency module of the first embodiment of the present invention. In the manufacturing method of FIG. 13, the second circuit block 20 is formed by mounting the passive element 110 on the upper surface of the second circuit board 20 using conductive connecting paste such as solder and sealing the upper surface of the second circuit board 20 with sealing resin 130. The first circuit block 210 is formed by mounting the semiconductor device 100 on the first grounding metal layer 70-a, which is formed on the bottom of the cavity 30 formed on the first circuit board 10, by means of face-up mounting using a conductive connecting paste such as solder paste or silver paste, and connecting the electrode terminals formed on the upper surface of the semiconductor device 100 with the transmission lines provided to the first circuit board 10 by use of bonding wires 120. The first circuit block 210 and the second circuit block 220 are vertically connected together and the first connection points 60-a formed on the upper surface of the first circuit board 10 are electrically connected with the second connection points 60-b formed on the lower surface of the second circuit board 20 by use of solder bumps, a conductive connecting agent such as silver paste or an anisotropic conductive sheet.

According to the above manufacturing method, the heat radiation section 40 and the first through-holes 50-a can be formed at once during the formation of the first circuit board 10 by means of a generally used method. Therefore, the heat release capability of the radio frequency module can be obtained more easily in comparison with the conventional manufacturing method stacking a dielectric substrate on the upper surface of a metal base.

Further, it is possible to test whether or not the semiconductor device of the first circuit block is broken or carry out characteristics evaluation of the semiconductor device before connecting the first circuit block with the second circuit block. By such selection of the first circuit blocks, connection of a second circuit block with a first circuit block which is broken or does not satisfy product conditions can be avoided, thereby the manufacturing yield of the radio frequency modules each of which is completed by connecting the first circuit block with the second circuit block can be increased.

Manufacturing methods for the radio frequency modules of the second through sixth embodiments are basically the same as that of the radio frequency module of the first embodiment which has been explained above. However, in the manufacturing method for the radio frequency module of the sixth embodiment, it is desirable that the inside of the cavity 30 formed on the first circuit board 10 be filled with nitrogen gas etc. when the first circuit block and the second circuit block are connected together, so that the degradation of metal terminals of the SAW element 270 can be avoided.

It is of course possible to manufacture the first circuit block and the second circuit block one by one and connect them together one by one. However, the following method can also be employed for the sake of simplification of the manufacturing method. In the method, a first circuit block sheet of approximately 10 cm×10 cm or larger including a plurality of first circuit blocks horizontally connected together and a second circuit block sheet, which includes a plurality of second circuit blocks horizontally connected together and is similarly to the first circuit block sheet, are manufactured first. Subsequently, the first circuit block sheet and the second circuit block sheet are vertically connected together. Thereafter, the connected circuit block sheet is cut and separated into a plurality of radio frequency modules by use of a dicer or router or by means of cleavage.

While the upper surface of the second circuit board 20 is sealed with sealing resin in the above manufacturing method, a resin case or a metal case can also be used for the sealing of the upper surface, as mentioned in the explanation of the composition of the radio frequency module.

In addition, while the upper surface of the second circuit block 20 is sealed with the sealing resin before the first circuit block and the second circuit block are vertically connected together in the above manufacturing method, it is also possible to carry out the sealing of the upper surface of the second circuit block 20 after connecting the first circuit block and the second circuit block together.

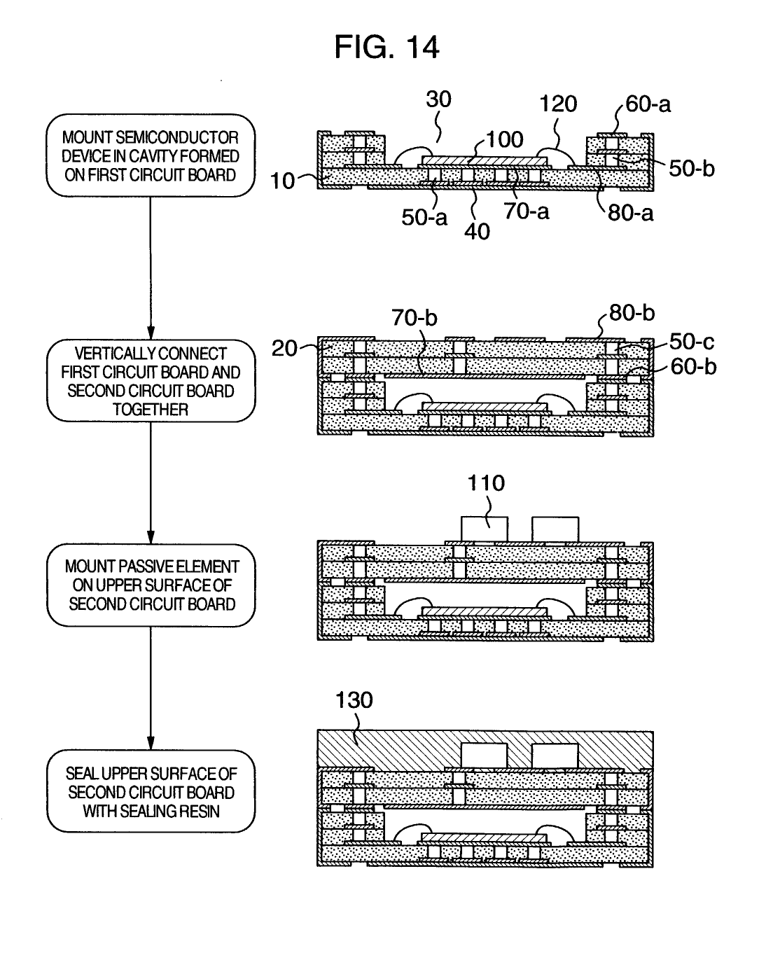

FIG. 14 is a flow chart briefly showing another method for manufacturing the radio frequency module of the first embodiment of the present invention. In the manufacturing method of FIG. 14, the first circuit block 210 is formed by mounting the semiconductor device 100 on the first grounding metal layer 70-a, which is formed on the bottom of the cavity 30 formed on the first circuit board 10, by means of face-up mounting using a conductive connecting paste such as solder paste or silver paste, and connecting the electrode terminals formed on the upper surface of the semiconductor device 100 with the transmission lines provided to the first circuit board 10 by use of bonding wires 120. Subsequently, the second circuit board 20 on which the passive element 110 is not mounted is connected onto the first circuit block while electrically connecting the first connection points 60-a formed on the upper surface of the first circuit board 10 with the second connection points 60-b formed on the lower surface of the second circuit board 20 by use of solder bumps, a conductive connecting agent such as silver paste, or an anisotropic conductive sheet. Thereafter, the passive element 110 is mounted on the upper surface of the second circuit board 20 using a conductive connecting paste such as solder and the upper surface of the second circuit board 20 is sealed with the sealing resin 130, thereby the second circuit block is completed and the whole radio frequency module is also completed at the same time.

In the above manufacturing method, the first circuit block is manufactured first and the second circuit board 20 is connected onto the first circuit block before the completion of the second circuit block, and thereafter the passive element 110 is mounted on the second circuit board 20 by the method, the adjustment of electrical matching between the semiconductor device 100 mounted on the first circuit block 210 and the passive element 110 mounted on the second circuit block 220 becomes easier. Also in this example, circuit blocks to be connected together can be selected properly based on necessary functions, therefore, it goes without saying that radio frequency modules for various applications can be manufactured and provided in a short period also by this manufacturing method.

In both manufacturing methods of FIGS. 13 and 14, it is also possible to purchase each of the first circuit block 210 and second circuit block 220 from one or more vendors, and thereafter connect them together. By such manufacturing methods, alteration of product specifications of the first circuit block 210 and the second circuit block 220 can be carried out more easily. The time and costs for the development and production can be reduced, or the first circuit block and the second circuit block can be acquired at any time from the vendors in proper amounts, thereby higher stability can be given to the production and distribution of the radio frequency modules.

(Seventh Embodiment)

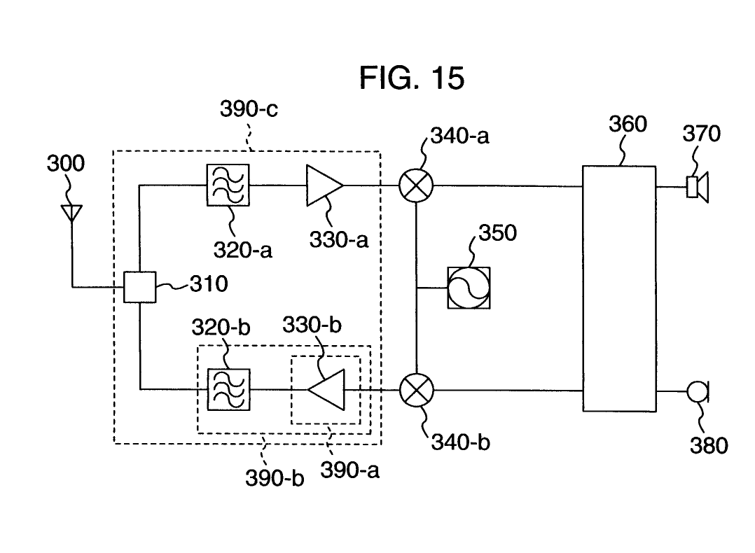

FIG. 15 is a circuit diagram showing a radio frequency mobile communication terminal in accordance with a seventh embodiment of the present invention. The radio frequency mobile communication terminal includes an antenna 300, a duplexer 310, filters 320 (a reception filter 320-a and a transmission filter 320-b), power amplifiers 330 (a reception power amplifier 330-a and a transmission power amplifier 330-b), mixers 340 (a reception mixer 340-a and a transmission mixer 340-b), a VCO (Voltage Controlled Oscillator) 350, a baseband unit 360, a speaker 370, and a microphone 380. Each reference numeral “390” (390-a, 390-b and 390-c) denotes a radio frequency module in accordance with the present invention. The radio frequency module 390 can be formed in various types like those of the first through sixth embodiments.

An audio signal inputted via the microphone 380 is converted by the baseband unit 360, combined by the transmission mixer 340-b with a local oscillation signal generated by the VCO 350, and is inputted to the transmission power amplifier 330-b. The audio signal amplified by the transmission power amplifier 330-b is inputted to the duplexer 310 via the transmission filter 320-b and is transmitted through the antenna 300 as a radio signal. Meanwhile, a radio signal received through the antenna 300 is inputted to the duplexer 310 as a signal, and the signal is inputted to the reception power amplifier 330-a via the reception filter 320-a. The received signal outputted from the reception power amplifier 330-a is combined by the reception mixer 340-a with the local oscillation signal generated by the VCO 350, is converted by the baseband unit 360, and is outputted from the speaker 370 as sound.

Reference numeral “390-a” in FIG. 15 denotes a case where a radio frequency module in accordance with the present invention is applied to the transmission power amplifier 330-b of the radio frequency mobile communication terminal. In this case, the radio frequency module 390-a can be formed in any composition selected from the first through fifth embodiments, in which the first, third and fifth embodiments are preferable. The semiconductor device 100 in each embodiment corresponds to the transmission power amplifier 330-b.

Reference numeral “390-b” in FIG. 15 denotes a case where a radio frequency module in accordance with the present invention is applied to the transmission power amplifier 330-b and the transmission filter 320-b of the radio frequency mobile communication terminal. In this case, the radio frequency module 390-b can be formed in the composition of the second or sixth embodiment. When the second embodiment is employed, the semiconductor device 100 and the passive element 110 correspond to the transmission power amplifier 330-b and the transmission filter 320-b, respectively. When the sixth embodiment is employed, the semiconductor device 100 and the SAW element 270 correspond to the transmission power amplifier 330-b and the transmission filter 320-b, respectively.

Reference numeral “390-c” in FIG. 15 denotes a case where a radio frequency module in accordance with the present invention is applied to the transmission power amplifier 330-b, the transmission filter 320-b, the reception power amplifier 330-a, the reception filter 320-a and the duplexer 310 of the radio frequency mobile communication terminal. In this case, the radio frequency module 390-c can have composition in which the second or sixth embodiment is combined with the fourth embodiment. In the case where the combination of the second and fourth embodiments is employed, the semiconductor device 100-b corresponds to the transmission power amplifier 330-b, the passive elements 110 correspond to the transmission filter 320-b and the reception filter 320-a, and the semiconductor device 100-a corresponds to the reception power amplifier 330-a. The passive element 110 corresponding to the transmission filter 320-b is placed in the cavity 30-b, and the passive element 110 corresponding to the reception filter 320-a is placed in the cavity 30-a. In the case where the combination of the fourth and sixth embodiments is employed, the semiconductor device 100-b corresponds to the transmission power amplifier 330-b, the SAW elements 270 correspond to the transmission filter 320-b and the reception filter 320-a, and the semiconductor device 100-a corresponds to the reception power amplifier 330-a. The SAW element 270 corresponding to the transmission filter 320-b is placed in the cavity 30-b, and the SAW element 270 corresponding to the reception filter 320-a is placed in the cavity 30-a.

According to the seventh embodiment, the radio frequency mobile communication terminal equipped with the radio frequency module can be miniaturized and the heat release capability of the terminal can be improved, thanks to the miniaturization and the improved heat release capability of the radio frequency module.

While the above description has been given mainly taking application to a radio frequency power amplifier module employed for a radio frequency mobile communication terminal as an example, the present invention is applicable not only to such radio frequency power amplifier modules but also to various radio frequency modules for various purposes, such as an antenna-filter-amplifier integral-type module.

According to the radio frequency module of the present invention, the reduction of circuit board area of the radio frequency module becomes possible. Further, heat emitted by a first circuit element group is transferred to the heat radiation section, which is formed on the lower surface of the first circuit board, via the first through-holes connecting the bottom of the cavity with the heat radiation section, thereby improved heat release capability can be obtained.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A radio frequency module comprising:
a first circuit block and a second circuit block, wherein:
the first circuit block includes:
a first circuit board;
a first circuit element placed on the first circuit board;
a heat radiation section formed on a surface of the first circuit board opposite to a surface on which the first circuit element is placed;
a first through-hole penetrating the first circuit board between the surface on which the first circuit element is placed and the heat radiation section, for transferring heat emitted by the first circuit element to the heat radiation section; and
a first connection point formed on a surface of the first circuit board opposite to the surface on which the heat radiation section is formed,
the second circuit block includes:
a second circuit board;
a second circuit element placed on the second circuit board; and
a second connection point formed on a surface of the second circuit board opposite to a surface on which the second circuit element is placed,
the first circuit block and the second circuit block are formed so as to be connectable with each other, and
a sealed cavity containing the first circuit element is completed and the first connection point makes contact with the second connection point so as to electrically connect the first circuit element with the second circuit element, when the first circuit block and the second circuit block are connected together.

2. A radio frequency module as claimed in claim 1, wherein:
the first circuit element includes a semiconductor active element mounted on the first circuit board so that a circuit surface is opposite to a bonded surface; and
the second circuit element includes a passive element.

3. A radio frequency module as claimed in claim 1, wherein:
the first circuit block includes a second through-hole for connecting the first circuit element with the first connection point; and
the second circuit block includes a third through-hole for connecting the second circuit element with the second connection point.

4. A radio frequency module as claimed in claim 1, wherein the second circuit block includes a grounding electrode on the surface of the second circuit board opposite to the surface on which the second circuit element is placed.

5. A radio frequency module as claimed in claim 1, wherein the heat radiation section is formed of a metal material having higher thermal conductivity than the first circuit board.

6. A radio frequency module comprising:
a circuit board formed so as to be divided into blocks;
an active element mounted on a lower circuit board by means of face-up mounting;
a passive element mounted on an upper circuit board; and
a thermal via-hole provided to the lower circuit board,
wherein heat emitted by the active element is transferred to a lower surface of the lower circuit board to be radiated through the thermal via-hole.

7. A radio frequency module comprising:
a first circuit block and a second circuit block, wherein:
the first circuit block includes:
a first circuit board;
a cavity formed on the first circuit board;
a first circuit element placed in the cavity;
a heat radiation section formed on a surface of the first circuit board opposite to a surface on which the cavity is formed;
a first through-hole penetrating the first circuit board between the bottom of the cavity and the heat radiation section, for transferring heat emitted by the first circuit element to the heat radiation section; and
a first connection point formed on a surface of the first circuit board opposite to the surface on which the heat radiation section is formed,
a second circuit block includes:
a second circuit board;
a second circuit element placed on the second circuit board; and
a second connection point formed on a surface of the second circuit board opposite to a surface on which the second circuit element is placed,
the first circuit block and the second circuit block are formed so as to be connectable with each other, and
the first connection point makes contact with the second connection point so as to electrically connect the first circuit element with the second circuit element, when the first circuit block and the second circuit block are connected together.

8. A radio frequency module comprising:
a first circuit block and a second circuit block, wherein:
the first circuit block includes:
a first circuit board;
a first circuit element placed on the first circuit board;
a heat radiation section formed on a surface of the first circuit board opposite to a surface on which the first circuit element is placed;
a first through-hole penetrating the first circuit board between the surface on which the first circuit element is placed and the heat radiation section, for transferring heat emitted by the first circuit element to the heat radiation section; and
a first connection point formed on a surface of the first circuit board opposite to the surface on which the heat radiation section is formed,
the second circuit block includes:
a second circuit board;
a cavity formed on the second circuit board;
a second circuit element placed on a surface of the second circuit board opposite to a surface on which the cavity is formed; and
a second connection point formed on a surface of the second circuit board opposite to the surface on which the second circuit element is placed,
the first circuit block and the second circuit block are formed so as to be connectable with each other, and
the first connection point makes contact with the second connection point so as to electrically connect the first circuit element with the second circuit element, when the first circuit block and the second circuit block are connected together.

9. A radio frequency module as claimed in claim 7, wherein:
the radio frequency module further comprises a third circuit block having composition similar to the second circuit block; and
the second circuit block and the third circuit block are connected with the first circuit block.

10. A radio frequency module as claimed in claim 7, wherein:
the first circuit element includes a semiconductor active element mounted on the first circuit board so that a circuit surface is opposite to a bonded surface, and
the second circuit element includes a passive element.

11. A radio frequency module as claimed in claim 10, wherein the first circuit element further includes a passive element.

12. A radio frequency module as claimed in claim 11, wherein the passive element is a SAW element.

13. A radio frequency module comprising:
a first circuit block, a second circuit block, and a third circuit block, wherein:
the first circuit block includes:
a first circuit board;
a first circuit element placed on the first circuit board;
a heat radiation section formed on a surface of the first circuit board opposite to a surface on which the first circuit element is placed;
a first through-hole penetrating the first circuit board between the surface on which the first circuit element is placed and the heat radiation section, for transferring heat emitted by the first circuit element to the heat radiation section; and
a first connection point formed on a surface of the first circuit board opposite to the surface on which the heat radiation section is formed,
the second circuit block includes:
a second circuit board;
a second circuit element placed on the second circuit board; and
a second connection point formed on a surface of the second circuit board opposite to a surface on which the second circuit element is placed, and
the third circuit block includes
a third circuit board;
a third circuit element built in the third circuit board;
a third connection point formed on a first surface of the third circuit board;
a fourth connection point formed on a second surface of the third circuit board opposite to the first surface,
the first circuit block, the second circuit block and the third circuit block are formed so as to be connected together with the third circuit block sandwiched between the first circuit block and the second circuit block, and
a sealed cavity containing the first circuit element is completed and the first connection point and the second connection point make contact with the third connection point and the fourth connection point, respectively, so as to electrically connect the first circuit element, the second circuit element and the third circuit element together, when the first circuit block, the second circuit block and the third circuit block are connected together.

14. A method for manufacturing a radio frequency module comprising the steps of:
forming a first circuit block by mounting a first circuit element on a first circuit board using conductive connecting material;
forming a second circuit block by mounting a second circuit element on a second circuit board using conductive connecting material, and sealing a surface of the second circuit board on which the second circuit element is mounted; and
connecting the first circuit block with the second circuit block, and electrically connecting a first connection point formed on a surface of the first circuit board on a side of the first circuit element, with a second connection point formed on a surface of the second circuit board opposite to the surface on which the second circuit element is mounted, using conductive connecting material.

15. A method for manufacturing a radio frequency module comprising the steps of:
forming a first circuit block by mounting a first circuit element on a first circuit board using conductive connecting material;
connecting the first circuit block with a second circuit board, and electrically connecting a first connection point formed on a surface of the first circuit board on a side of the first circuit element, with a second connection point formed on the second circuit board, using conductive connecting material; and
forming a second circuit block by mounting a second circuit element on a surface of the second circuit board opposite to a surface on which the second connection point is formed, using conductive connecting material, and sealing the surface of the second circuit board on which the second circuit element is mounted.

16. A method for manufacturing a radio frequency module comprising the steps of:
forming a first circuit block, the first circuit including a first circuit board; a first circuit element placed on the first circuit board; a heat radiation section formed on a surface of the first circuit board opposite to a surface on which the first circuit element is placed; a first through-hole penetrating the first circuit board between the surface on which the first circuit element is placed and the heat radiation section, for transferring heat emitted by the first circuit element to the heat radiation section, and a first connection point formed on a surface of the first circuit board opposite to the surface on which the heat radiation section is formed;
forming a first-purpose second circuit block, the first-purpose second circuit including a second circuit board; and a second connection point formed on the second circuit board;
forming a second-purpose second circuit block, the second-purpose second circuit block including a second circuit board; and a second connection point formed on the second circuit board, and the second-purpose second circuit block having a circuit pattern similar to a circuit pattern of the first-purpose second circuit block; and
forming a first-purpose radio frequency module by connecting the first circuit block with the first purpose second circuit block if a product for a first-purpose product is required, while forming a second-purpose radio frequency module by connecting the first circuit block with the second-purpose second circuit block if a second-purpose product is required,
wherein the first circuit block and the second circuit block are formed so as to be connectable with each other; and
a sealed cavity containing the first circuit element is completed and the first connection point makes contact with the second connection point so as to electrically connect the first circuit element with a second circuit element formed in the second circuit block, when the first circuit block and the second circuit block are connected together.

17. A method for manufacturing a radio frequency module as claimed in claim 16, wherein
the step of forming the first-purpose second circuit block or the step of forming the second-purpose second circuit block further includes a step for mounting the second circuit element on a surface of the second circuit board opposite to a surface on which the second connection point is formed.

18. A radio frequency mobile communication terminal, comprising:
an antenna;
a baseband unit; and
a radio frequency module having function for amplifying a signal outputted from the baseband unit by the radio frequency module, and transmitting the amplified radio frequency signal through the antenna, wherein:
the radio frequency module comprising a first circuit block and a second circuit block, wherein
the first circuit block includes:
a first circuit board;
a first circuit element placed on the first circuit board;
a heat radiation section formed on a surface of the first circuit board opposite to a surface on which the first circuit element is placed;
a first through-hole penetrating the first circuit board between the surface on which the first circuit element is placed and the heat radiation section, for transferring heat emitted by the first circuit element to the heat radiation section; and
a first connection point formed on a surface of the first circuit board opposite to the surface on which the heat radiation section is formed,
the second circuit block includes:
a second circuit board;
a second circuit element placed on the second circuit board; and
a second connection point which is formed on a surface of the second circuit board opposite to a surface on which the second circuit element is placed,
the first circuit block and the second circuit block are formed so as to be connectable with each other, and
a sealed cavity containing the first circuit element is completed and the first connection point makes contact with the second connection point so as to electrically connect the first circuit element with the second circuit element, when the first circuit block and the second circuit block are connected together.

19. A radio frequency mobile communication terminal as claimed in claim 18, further having function for converting a radio frequency signal, which is received from the antenna, into an intermediate frequency signal by the radio frequency module, and inputting the converted radio frequency signal to the baseband unit.
